(19) United States
(12) Patent Application Publication
(10) Pub. No.: US 2024/0340666 A1
(43) Pub. Date: Oct. 10, 2024

(54) MEASUREMENTS ASSOCIATED WITH A MAIN RADIO AND A LOW-POWER WAKE UP RECEIVER

(71) Applicant: QUALCOMM Incorporated, San Diego, CA (US)

(72) Inventors: Prashant SHARMA, San Marcos, CA (US); Ahmed ELSHAFIE, San Diego, CA (US); Changhwan PARK, San Diego, CA (US); Linhai HE, San Diego, CA (US)

(21) Appl. No.: 18/619,415

(22) Filed: Mar. 28, 2024

Related U.S. Application Data
(60) Provisional application No. 63/494,863, filed on Apr. 7, 2023.

(51) Int. Cl. H04W 24/08; H04B 17/318

(52) U.S. Cl. CPC H04W 24/08; H04B 17/328

(57) ABSTRACT

Various aspects of the present disclosure generally relate to wireless communication. In some aspects, a user equipment (UE) may receive configuration information configuring measurement of a first radio resource management (RRM) communication associated with a low-power wake up receiver (LP-WUR) and a second RRM communication associated with a main radio (MR). The UE may perform, based at least in part on the configuration information, a first set of measurements associated with the first RRM communication using the LP-WUR and a second set of measurements associated with the second RRM communication using the MR. The UE may trigger an RRM procedure using one of: a combination of the first set of measurements and the second set of measurements, or a selection of a set of measurements, from the first set measurements or the second set of measurements. Numerous other aspects are described.

### CROSS-REFERENCE TO RELATED APPLICATION

This Patent application claims priority to U.S. Provisional Patent Application No. 63/494,863, filed on Apr. 7, 2023, entitled “MEASUREMENTS ASSOCIATED WITH A MAIN RADIO AND A LOW-POWER WAKE UP RECEIVER,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for measurements associated with a main radio and a low-power wake up receiver.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving configuration information configuring measurement of a first radio resource management (RRM) communication associated with a low-power wake up receiver (LP-WUR) and a second RRM communication associated with a main radio (MR). The method may include performing, based at least in part on the configuration information, a first set of one or more measurements associated with the first RRM communication using the LP-WUR and a second set of one or more measurements associated with the second RRM communication using the MR. The method may include triggering an RRM procedure using one of a combination of the first set of one or more measurements and the second set of one or more measurements, or a selection of a set of one or more measurements, from the first set of one or more measurements or the second set of one or more measurements.

Some aspects described herein relate to a method of wireless communication performed by a network node. The method may include transmitting, to a UE, configuration information configuring measurement of a first RRM communication associated with an LP-WUR and a second RRM communication associated with an MR. The method may include transmitting, to the UE, the first RRM communication and the second RRM communication. The method may include receiving, from the UE, a message triggering an RRM procedure that is based at least in part on one of a combination of a first set of one or more measurements associated with the first RRM communication and a second set of one or more measurements associated with the second RRM communication, or a selection of a set of one or more measurements, from the first set of one or more measurements or the second set of one or more measurements.

Some aspects described herein relate to a UE for wireless communication. The UE may include one or more memories and one or more processors coupled to the one or more memories. The one or more memories may include instructions executable by the one or more processors to cause the UE to receive configuration information configuring measurement of a first RRM communication associated with an LP-WUR and a second RRM communication associated with an MR. The one or more memories may include instructions executable by the one or more processors to cause the UE to perform, based at least in part on the configuration information, a first set of one or more measurements associated with the first RRM communication using the LP-WUR and a second set of one or more measurements associated with the second RRM communication using the MR. The one or more memories may include instructions executable by the one or more processors to cause the UE to trigger an RRM procedure using one of a combination of the first set of one or more measurements and the second set of one or more measurements, or a selection of a set of one or more measurements, from the first set of one or more measurements or the second set of one or more measurements.

Some aspects described herein relate to a network node for wireless communication. The network node may include one or more memories and one or more processors coupled to the one or more memories. The one or more memories may include instructions executable by the one or more processors to cause the network node to transmit, to a UE, configuration information configuring measurement of a first RRM communication associated with an LP-WUR and a second RRM communication associated with an MR. The one or more memories may include instructions executable by the one or more processors to cause the network node to transmit, to the UE, the first RRM communication and the second RRM communication. The one or more memories may include instructions executable by the one or more processors to cause the network node to receive, from the UE, a message triggering an RRM procedure that is based at least in part on one of a combination of the first set of one or more measurements and the second set of one or more measurements, or a selection of a set of one or more measurements, from the first set of one or more measurements or the second set of one or more measurements.

Some aspects described herein relate to a non-transitory computer-readable medium that stores one or more instructions for wireless communication by a UE. The one or more instructions, when executed by one or more processors of the UE, may cause the UE to receive configuration information configuring measurement of a first RRM communication associated with an LP-WUR and a second RRM communication associated with an MR. The one or more instructions, when executed by one or more processors of the UE, may cause the UE to perform, based at least in part on the configuration information, a first set of one or more measurements associated with the first RRM communication using the LP-WUR and a second set of one or more measurements associated with the second RRM communication using the MR. The one or more instructions, when executed by one or more processors of the UE, may cause the UE to trigger an RRM procedure using one of a combination of the first set of one or more measurements and the second set of one or more measurements, or a selection of a set of one or more measurements, from the first set of one or more measurements or the second set of one or more measurements.

Some aspects described herein relate to a non-transitory computer-readable medium that stores one or more instructions for wireless communication by a network node. The one or more instructions, when executed by one or more processors of the network node, may cause the network node to transmit, to a UE, configuration information configuring measurement of a first RRM communication associated with an LP-WUR and a second RRM communication associated with an MR. The one or more instructions, when executed by one or more processors of the network node, may cause the network node to transmit, to the UE, the first RRM communication and the second RRM communication. The one or more instructions, when executed by one or more processors of the network node, may cause the network node to receive, from the UE, a message triggering an RRM procedure that is based at least in part on one of a combination of the first set of one or more measurements and the second set of one or more measurements, or a selection of a set of one or more measurements, from the first set of one or more measurements or the second set of one or more measurements.

Some aspects described herein relate to an apparatus for wireless communication. The apparatus may include means for receiving configuration information configuring measurement of a first RRM communication associated with an LP-WUR and a second RRM communication associated with an MR. The apparatus may include means for performing, based at least in part on the configuration information, a first set of one or more measurements associated with the first RRM communication using the LP-WUR and a second set of one or more measurements associated with the second RRM communication using the MR. The apparatus may include means for triggering an RRM procedure using one of a combination of the first set of one or more measurements and the second set of one or more measurements, or a selection of a set of one or more measurements, from the first set of one or more measurements or the second set of one or more measurements.

Some aspects described herein relate to an apparatus for wireless communication. The apparatus may include means for transmitting, to a UE, configuration information configuring measurement of a first RRM communication associated with an LP-WUR and a second RRM communication associated with an MR. The apparatus may include means for transmitting, to the UE, the first RRM communication and the second RRM communication. The apparatus may include means for receiving, from the UE, a message triggering an RRM procedure that is based at least in part on one of a combination of a first set of one or more measurements associated with the first RRM communication and a second set of one or more measurements associated with the second RRM communication, or a selection of a set of one or more measurements, from the first set of one or more measurements or the second set of one or more measurements.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of multiple receivers associated with a UE, in accordance with the present disclosure.

FIG. 5 is a diagram of an example associated with measurements associated with a main radio and a low-power wake up receiver, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

In some wireless communication systems, a user equipment (UE) may be equipped with multiple radios and/or receivers for communicating with a network node. For example, in addition to a main radio (MR), a UE may include a low-power wake up receiver (LP-WUR) (sometimes referred to as a low-power wake up radio and/or an ultra LP-WUR) for purposes of receiving wake up signals (WUSs) and/or performing measurements when an MR is in an OFF mode or a sleep state. In this way, the UE may reduce power consumption when data communications are not being communicated between the UE and the network node by entering a sleep state (e.g., by turning an MR off) and listening for a WUS using the LP-WUR. If the network node has data or similar information to communicate to the UE, the network node may transmit a WUS to the UE. Upon receiving the WUS via the LP-WUR, the UE may wake up the MR and thus receive the data communication from the network node using the MR. In this way, the UE is able to conserve power when data is not being transmitted between the UE and the network node, while maintaining a mechanism to quickly enable the MR to receive a data communication, when necessary.

In some examples, the UE may need to periodically wake up the MR even if the network node does not have data to transmit to the UE and/or even if the network node does not transmit a WUS to the UE. For example, the UE may need to periodically wake up an MR to perform a radio resource management (RRM) measurement, such as for purposes of measuring a reference signal associated with cell selection and/or cell reselection. In such cases, the UE may periodically wake up the MR to receive and/or measure a synchronization signal block (SSB) or a similar communication for purposes of RRM. In this way, even when equipped with an LP-WUR, the UE may not experience a significant reduction in power consumption because the UE may need to utilize the MR to perform cell-selection related measurements and/or other RRM measurements.

According to some aspects of the disclosure, a UE may be enabled to perform at least some RRM measurements, such as cell-selection related measurements, using an LP-WUR, thus reducing power consumption at the UE as compared to a UE that only performs RRM measurements using an MR. In some aspects, the UE may be configured to receive multiple RRM communications, such as a first RRM communication associated with an LP-WUR (e.g., a low-power synchronization signal (LP-SS) or a similar communication), and a second RRM communication associated with an MR (e.g., an SSB or a similar communication). Accordingly, the UE may perform a first set of RRM measurements using the LP-WUR and perform a second set of RRM measurements using the MR. Moreover, in some aspects, the UE may be configured to select a set of measurements to use when triggering an RRM procedure, or else the UE may be configured to combine the measurements for purposes of triggering the RRM procedure. For example, the UE may be configured to combine LP-WUR measurements and MR measurements, and thus the UE may ultimately trigger an RRM procedure (e.g., a cell-selection procedure) based at least in part on a combination of LP-WUR measurements and MR measurements. In some other aspects, the UE may be configured to select one of the LP-WUR measurements or the MR measurements based on a best-measured metric or a worst-measured metric, and thus the UE may ultimately trigger an RRM procedure (e.g., a cell-selection procedure) based at least in part on a selected one of the LP-WUR measurements or the MR measurements.

In this way, the UE may reduce power consumption as compared to UEs that only perform RRM measurements using an MR. Moreover, the UE may maintain a robust communication link based on performing RRM measurements using multiple receivers, thereby reducing communication errors and thus power, computing, and network resource consumption otherwise required for correcting communication errors.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

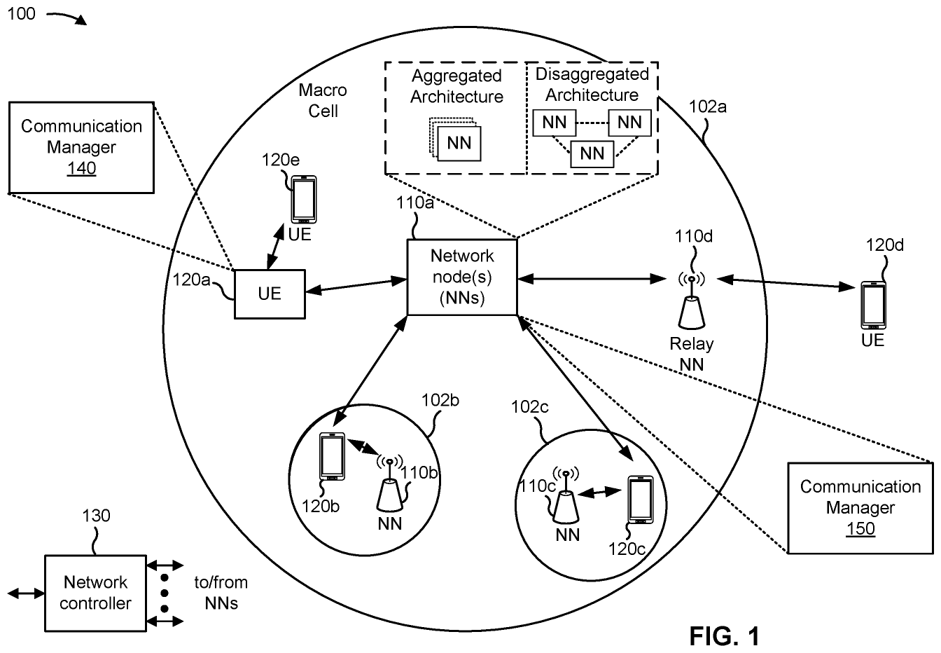

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 megahertz (MHz)-7.125 gigahertz (GHz)) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information configuring measurement of a first RRM communication associated with an LP-WUR and a second RRM communication associated with an MR; perform, based at least in part on the configuration information, a first set of one or more measurements associated with the first RRM communication using the LP-WUR and a second set of one or more measurements associated with the second RRM communication using the MR; and trigger an RRM procedure using one of: a combination of the first set of one or more measurements and the second set of one or more measurements, or a selection of a set of one or more measurements, from the first set of one or more measurements or the second set of one or more measurements. Additionally, or alternatively, the communication manager 140 may perform one or more other operations described herein.

In some aspects, the network node 110 may include a communication manager 150. As described in more detail elsewhere herein, the communication manager 150 may transmit, to a UE, configuration information configuring measurement of a first RRM communication associated with an LP-WUR and a second RRM communication associated with an MR; transmit, to the UE, the first RRM communication and the second RRM communication; and receive, from the UE, a message triggering an RRM procedure that is based at least in part on one of: a combination of a first set of one or more measurements associated with the first RRM communication and a second set of one or more measurements associated with the second RRM communication, or a selection of a set of one or more measurements, from the first set of one or more measurements or the second set of one or more measurements. Additionally, or alternatively, the communication manager 150 may perform one or more other operations described herein.

As indicated above, FIG. 1 is provided as an example. Other examples may differ from what is described with regard to FIG. 1.

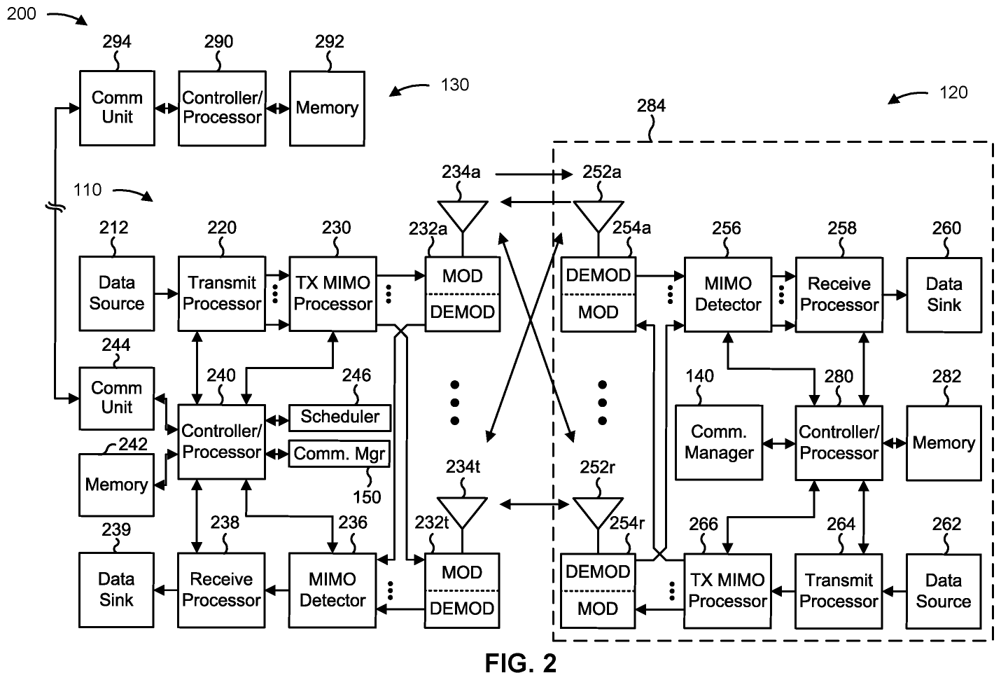

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

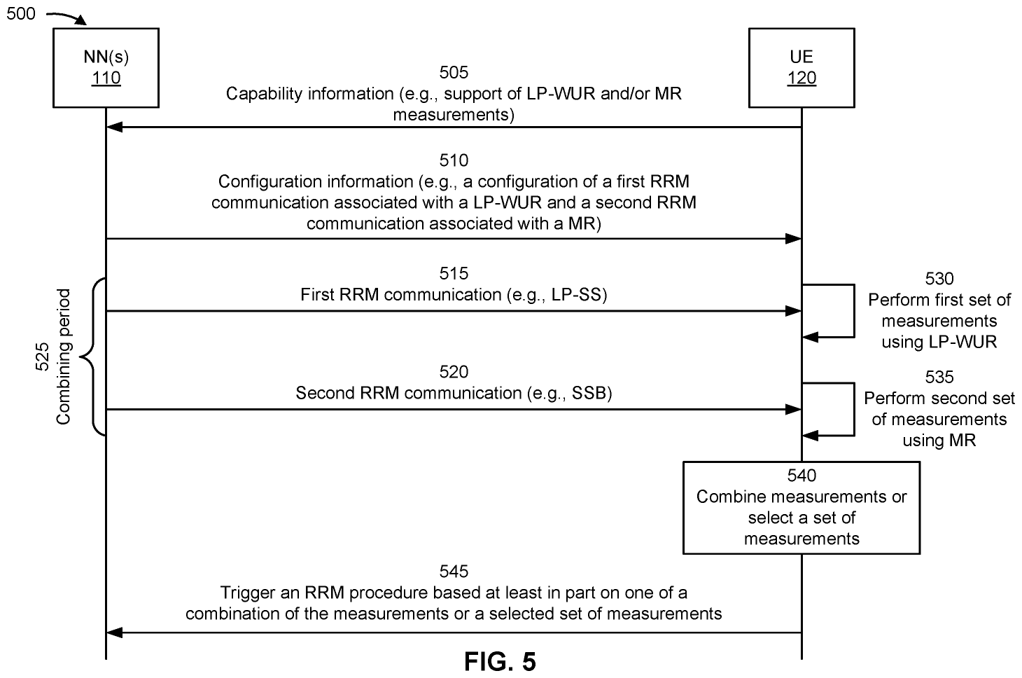

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

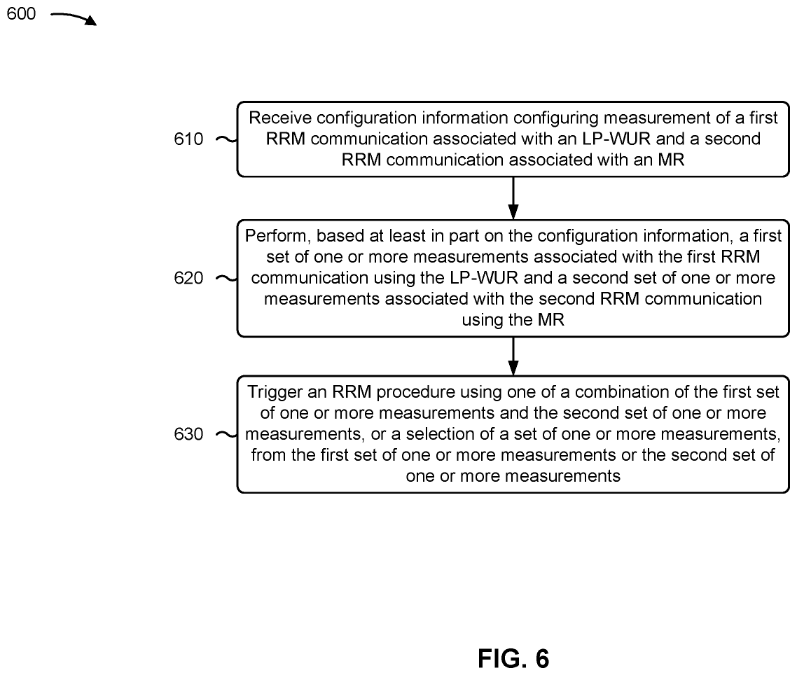

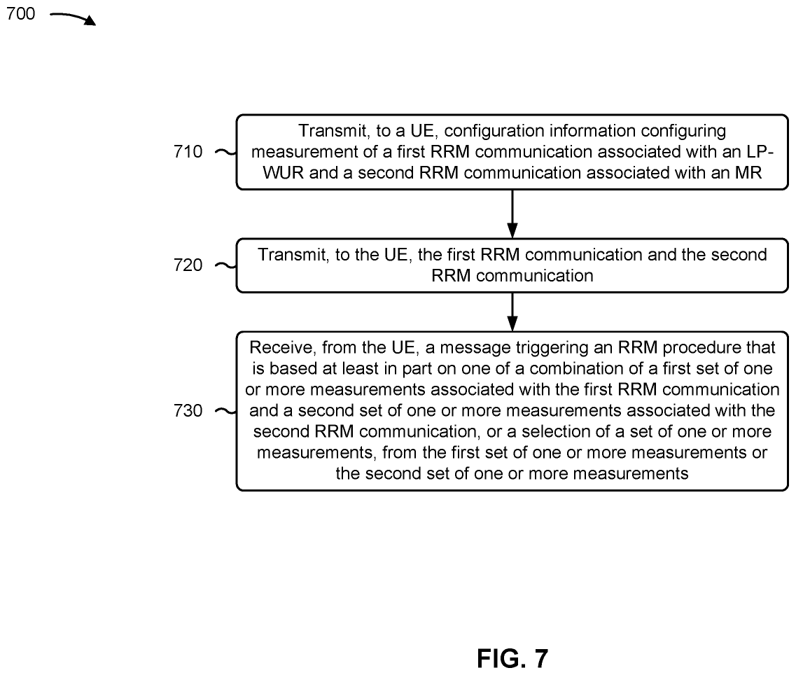

The controller/processor 240 of the network node 110, the controller/processor 280 of the UE 120, and/or any other component(s) of FIG. 2 may perform one or more techniques associated with measurements associated with a main radio and a low-power wake up receiver, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving configuration information configuring measurement of a first RRM communication associated with an LP-WUR and a second RRM communication associated with an MR; means for performing, based at least in part on the configuration information, a first set of one or more measurements associated with the first RRM communication using the LP-WUR and a second set of one or more measurements associated with the second RRM communication using the MR; and/or means for triggering an RRM procedure using one of: a combination of the first set of one or more measurements and the second set of one or more measurements, or a selection of a set of one or more measurements, from the first set of one or more measurements or the second set of one or more measurements. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE, configuration information configuring measurement of a first RRM communication associated with an LP-WUR and a second RRM communication associated with an MR; means for transmitting, to the UE, the first RRM communication and the second RRM communication; and/or means for receiving, from the UE, a message triggering an RRM procedure that is based at least in part on one of: a combination of a first set of one or more measurements associated with the first RRM communication and a second set of one or more measurements associated with the second RRM communication, or a selection of a set of one or more measurements, from the first set of one or more measurements or the second set of one or more measurements. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

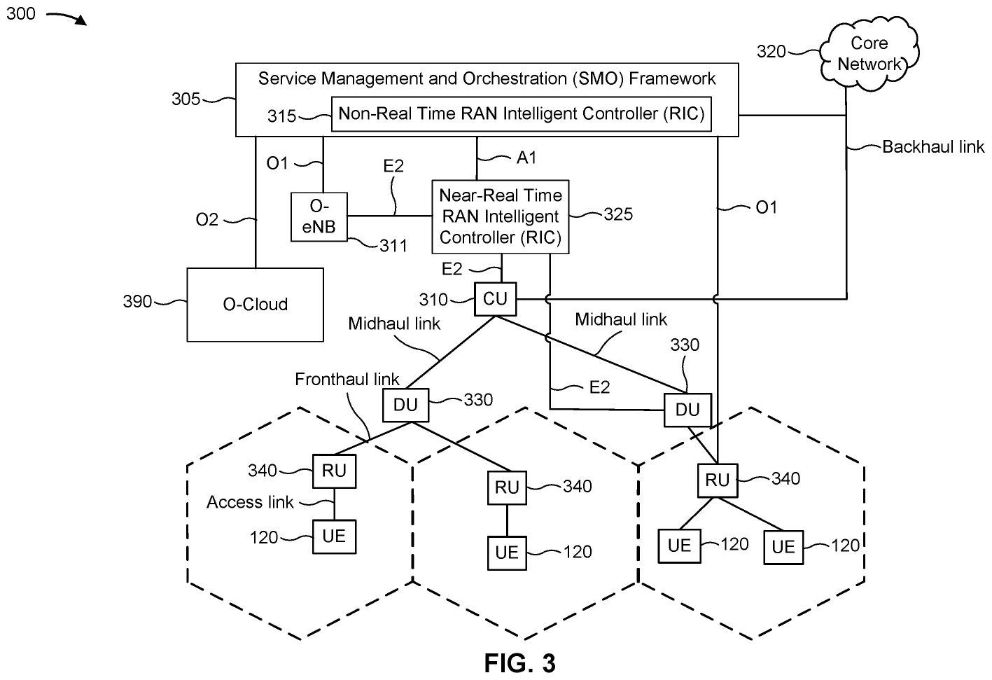

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through FI interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

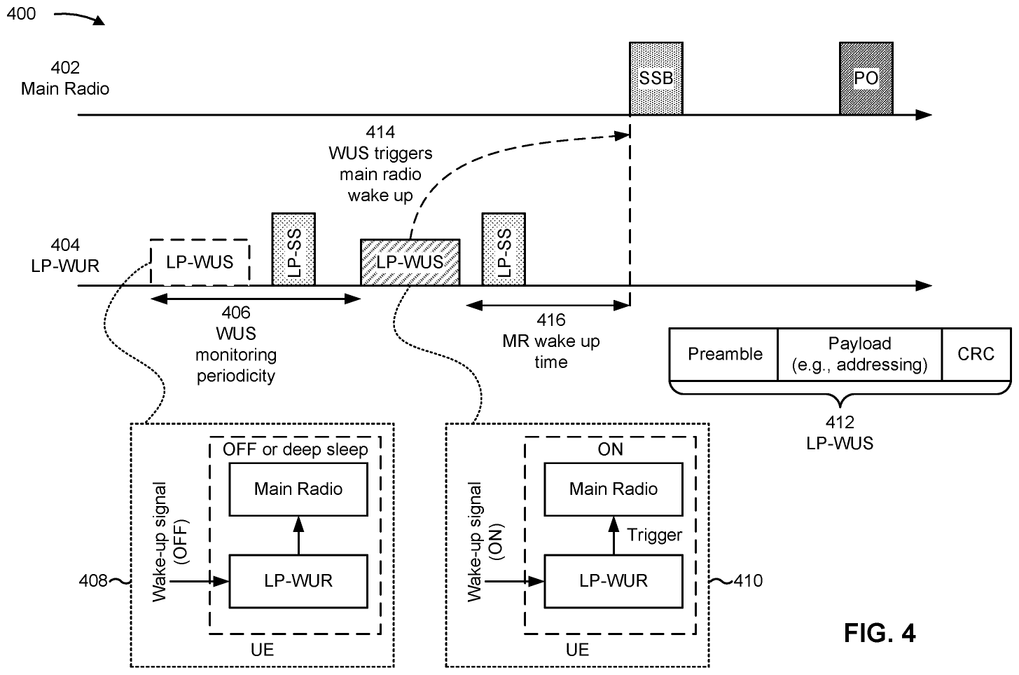

FIG. 4 is a diagram illustrating an example 400 of multiple receivers associated with a UE, in accordance with the present disclosure.

As shown in FIG. 4, in some examples, a UE 120 may include multiple radios and/or receivers, such as an MR (indicated by reference number 402) and an LP-WUR (indicated by reference number 404), among other radios and/or receivers. An MR may be a receiver associated with normal wireless traffic and/or may be associated with relatively high energy consumption, while an LP-WUR may be associated with a relatively simple radio receiver circuit designed to have a very low energy consumption. In some examples, the UE 120 may be configured to detect, receive, and/or measure different types of signals and/or communications using each radio and/or receiver. For example, the UE 120 may be configured to receive normal wireless communication traffic (e.g., SSBs, control signaling, data communications, and/or similar traffic) using the MR, and the UE 120 may be configured to receive low-power signals (e.g., low-power WUSs (LP-WUSs), low-power synchronization signals (LP-SSs), and/or similar low-power signals) using the LP-WUR. In some examples, the UE 120 may be capable of powering off one or more radios and/or receivers when not in use, such as for a purpose of reducing power consumption at the UE 120. For example, when the UE 120 does not have data to transmit to a network node 110 and the network node 110 does not have data to transmit to the UE 120, the UE 120 may turn an MR off, or else have the MR enter a sleep state in order to conserve power at the UE 120.

In some examples, as shown by reference number 406, the UE 120 may be configured with a WUS monitoring period, during which the LP-WUR may monitor for an LP-WUS, an LP-SS, or a similar low-power signal. As shown by reference number 408, if the UE 120 (and, more particularly, the LP-WUR of the UE 120) does not detect an LP-WUS, the UE 120 may maintain the MR in an OFF mode, a sleep state, an ultra-low-power state (ULPS), or a similar low-power state. In some cases, when the MR remains in the OFF mode, the UE 120 may synchronize timing with the network node 110 based on an LP-SS. More particularly, the UE 120 may receive the LP-SS using the L-WUR and synchronize timing with the network node based at least in part on the LP-SS, among other tasks.

As shown by reference number 410, if the UE 120 (and, more particularly, the LP-WUR of the UE 120) detects an LP-WUS during a WUS monitoring period, the LP-WUR may trigger the MR to wake up and/or enter an ON mode to receive a communication from the network node 110. Put another way, the network node 110 may transmit an LP-WUS to the UE 120 on demand to indicate to the UE 120 that the network node 110 has signaling and/or data to transmit to the UE 120. As shown by reference number 412, in some examples, the LP-WUS may be associated with a relatively simple structure that includes a preamble, a payload (e.g., addressing information), and/or a cyclic redundancy check (CRC). When the UE 120 detects the LP-WUS, the UE 120 triggers an MR wake up procedure (as shown by reference number 414). In some examples, the MR may be associated with a period of time that is required to fully wake up the MR and/or for the MR to enter an ON mode, as shown by reference number 416. During the MR wake up time, the UE 120 may continue to receive signals and/or communications via the LP-WUR, such as an LP-SS or similar communication. Once the MR is fully operational, the UE 120 may thereafter perform operations using the MR, such as measuring an SSB for purposes of synchronizing timing with the network.

In some examples, an LP-WUS may be used to reduce unnecessary UE paging receptions for an idle or inactive UE 120, which may otherwise be resource-intensive for the UE 120. In such cases, the network node 110 may transmit the LP-WUS only when there is paging for an idle or inactive mode UE 120. If the LP-WUS is detected, as shown in FIG. 4, the UE 120 may turn on the MR and/or wake up the MR, monitor an SSB using the MR prior to a paging occasion (PO) for synchronization with the network, and/or receive a paging communication in the PO using the MR. If the LP-WUS is not detected (meaning, in this example, that there is no paging intended for the idle or inactive UE 120), the UE 120 may maintain the MR in a ULPS or similar low-power mode in order to conserve power resources at the UE 120.

In some cases, notwithstanding that the network node 110 may not have data to transmit to the UE 120, the UE 120 may nonetheless need to periodically wake up, such as for purposes of performing RRM measurements associated with cell reselection or another RRM procedure. In such cases, a UE 120 utilizing an LP-WUR may not significantly reduce power consumption, because the MR may need to wake up frequently in order to perform the cell-selection related measurements. Accordingly, in such cases, the UE 120 may experience high power consumption even when employing an LP-WUR.

Some techniques and apparatuses described herein enable a UE 120 to reduce power consumption by performing cell-reselection procedures or similar RRM procedures using an LP-WUR. In some aspects, the UE 120 may be configured to perform both MR RRM measurements (e.g., using an SSB) and LP-WUR RRM measurements (e.g., using an LP-SS). The UE 120 may further be configured to combine the RRM measurements or else select one set of measurements for performing an RRM procedure, such as a cell-selection procedure. For example, when the UE 120 is configured to combine the RRM measurements, the UE 120 may be configured with certain parameters to enable combining of measurements performed using the MR and measurements performed using the LP-WUR. And when the UE 120 is configured to select one set of measurements, the UE 120 may be configured with selection criteria, such as selecting a set of measurements associated with a highest measurement quantity, a lowest measurement quantity, or a similar attribute. Accordingly, the UE 120 may trigger an RRM procedure (e.g., a cell-reselection procedure) using one of a combination of MR measurements and LP-WUR measurements or else a selection of a set of measurements, from the MR measurements or the LP-WUR measurements. In this way, an idle mode UE 120 or similar UE 120 may be able to perform many RRM measurements using the LP-WUR rather than the power-intensive MR, thereby reducing power consumption at the UE 120, while maintaining a robust wireless communication link between the network node 110 and the UE 120, thereby reducing communication errors and thus power, computing, and network resource consumption otherwise required to correct communication errors.

As indicated above, FIG. 4 is provided as an example. Other examples may differ from what is described with respect to FIG. 4.

FIG. 5 is a diagram of an example 500 associated with measurements associated with an MR and an LP-WUR, in accordance with the present disclosure. As shown in FIG. 5, a network node 110 (e.g., a CU, a DU, and/or an RU) may communicate with a UE 120. In some aspects, the network node 110 and the UE 120 may be part of a wireless network (e.g., wireless network 100). The UE 120 and the network node 110 may have established a wireless connection prior to operations shown in FIG. 5. In some aspects, the UE 120 may be associated with multiple radios and/or receivers, such as an MR and an LP-WUR.

As shown by reference number 505, the UE 120 may transmit, and the network node 110 may receive, capability information (e.g., a capabilities report). In some aspects, the capability information may indicate UE 120 support of LP-WUR measurements and/or MR measurements. For example, in aspects in which the UE 120 is equipped with both an LP-WUR and an MR, and/or aspects in which the UE 120 is capable of performing both LP-WUR measurements and MR measurements, the UE 120 may indicate, via the capability information, that the UE 120 has a capability to perform both LP-WUR measurements and MR measurements, such as for purposes of performing RRM measurements (e.g., measurements associated with cell selection) or similar types of measurements. Additionally, or alternatively, the capability information may indicate UE 120 support for combining measurements from two or more receivers, such as for purposes of triggering an RRM procedure based at least in part on a combination of measurements (which is described in more detail in connection with reference numbers 540 and 545). For example, the capability information may indicate UE 120 support for combining LP-WUR measurements and MR measurements, among other examples.

As shown by reference number 510, the network node 110 may transmit, and the UE 120 may receive, configuration information. In some aspects, the configuration information may be based at least in part on the capability information (e.g., a capability of the UE 120 to perform LP-WUR measurements and/or MR measurements, and/or a capability of the UE 120 to combine LP-WUR measurements and/or MR measurements). In some aspects, the UE 120 may receive the configuration information via one or more of RRC signaling, one or more MAC control elements (MAC-CEs), and/or downlink control information (DCI), among other examples. In some aspects, the configuration information may include an indication of one or more configuration parameters (e.g., already known to the UE 120 and/or previously indicated by the network node 110 or other network device) for selection by the UE 120, and/or explicit configuration information for the UE 120 to use to configure the UE 120, among other examples.

In some aspects, the configuration information may configure measurement of a first RRM communication associated with an LP-WUR and a second RRM communication associated with an MR. More particularly, the configuration information may indicate time resources, frequency resources, communication parameters, and/or similar information associated with a first RRM communication (e.g., a communication associated with an LP-WUR), such as the first RRM communication shown by reference number 515, and a second RRM communication (e.g., a communication associated with an MR), such as the second RRM communication shown by reference number 520. In some aspects, the first RRM communication may be associated with an LP-SS (e.g., a synchronization signal receivable and/or measurable by the LP-WUR), and/or the second RRM communication may be associated with an SSB (e.g., a synchronization signal receivable and/or measurable by the MR).

In some aspects, the configuration information may indicate an RRM mode associated with an RRM procedure. For example, the configuration information may include a configured RRM mode information element (IE) (sometimes referred to as a configuredRRMmode IE) that indicates a combination and/or selection procedure to be performed by the UE 120 in connection with performing an RRM procedure. In some aspects, the configured RRM mode IE may indicate that the UE 120 is to perform the RRM procedure based at least in part on a first mode that is associated with using the combination of the first set of one or more measurements (e.g., LP-WUR measurements) and the second set of one or more measurements (e.g., MR measurements), which is sometimes referred to as a “combine” configuration (e.g., the configuredRRMmode IE may be set to “combine”). For example, the UE 120 may be configured to perform the RRM procedure based at least in part on combining the first set of one or more measurements (e.g., LP-WUR measurements) and the second set of one or more measurements (e.g., MR measurements) in order to realize certain power savings at the UE (e.g., associated with performing some of the measurements using the LP-WUR) while also maintaining a certain level of accuracy (e.g., by including at least some MR measurements, which may have a higher accuracy and/or a greater reliability than LP-WUR measurements).

In some aspects, the configured RRM mode IE may indicate that the UE 120 is to perform the RRM procedure based at least in part on a second mode that is associated with a selection of a set of one or more measurements (e.g., one of LP-WUR measurements or MR measurements) that is associated with a highest measurement quantity (e.g., a highest RSRP value, a highest RSRQ value, a highest signal-to-interference-plus-noise ratio (SINR) value, or a similar measurement quantity). In some aspects, the second mode may be referred to as a “selection” configuration (e.g., the configuredRRMmode IE may be set to “selection”). For example, the UE 120 may be configured to perform the RRM procedure based at least in part on selecting a set of one or more measurements (e.g., one of LP-WUR measurements or MR measurements) that is associated with a highest measurement quantity so that the UE 120 may not trigger neighbor cell measurements when only one of the measurement metrics is lower than a corresponding threshold. This may prevent unnecessary neighbor cell measurements and thus may result in power savings in scenarios in which the UE 120 is still operating under good cell conditions but, for whatever reason, one of the radios (e.g., one of the LP-WUR or the MR) makes bad measurements, among other examples.

In some other aspects, the configured RRM mode IE may indicate that the UE 120 is to perform the RRM procedure based at least in part on a third mode that is associated with a selection of a set of one or more measurements (e.g., one of LP-WUR measurements or MR measurements) that is associated with a lowest measurement quantity (e.g., a lowest RSRP value, a lowest RSRQ value, a lowest SINR value, or a similar measurement quantity). In some aspects, the third mode may be referred to as a “worst case” configuration (e.g., the configuredRRMmode IE may be set to “worst-case”). For example, the UE 120 may be configured to perform the RRM procedure based at least in part on selecting a set of one or more measurements (e.g., one of LP-WUR measurements or MR measurements) that is associated with a lowest measurement quantity so that the UE 120 may trigger neighbor cell measurements even if one of the measurement metrics is lower than a corresponding threshold, which may prevent cell reselection delays when the UE 120 is operating near a cell edge and/or when UE 120 mobility is high. In such aspects, configuring the UE 120 to perform the RRM procedure based at least in part on selecting a set of one or more measurements that is associated with a lowest measurement quantity (e.g., setting the configuredRRMmode IE may be set to “worst-case”) may result in reduced power savings as compared to one or more other modes (e.g., as compared to the selection configuration described above) but may result in a reduced probability of interrupted service at the UE 120.

Additionally, or alternatively, in some aspects, the configuration information may configure the UE 120 to use only one set of one or more measurements (e.g., only one of LP-WUR measurements or MR measurements). For example, in aspects in which the UE 120 is operating under good cell conditions and the UE 120 is stationary or else mobility is relatively low, the UE 120 may be configured to perform full measurement offloading to the LP-WUR, such as for a purpose of realizing optimal power savings at the UE 120.

In some aspects, such as in aspects in which the UE 120 is configured to combine measurements from multiple receivers (e.g., LP-WUR measurements and MR measurements), such as when the configuredRRMmode IE is set to combine, the configuration information may further indicate certain parameters associated with combining measurements from the multiple receivers. For example, in some aspects, the configuration information may indicate a first transmit power boosting factor associated with the first set of one or more measurements (e.g., LP-WUR measurements) and a second transmit power boosting factor associated with the second set of one or more measurements (e.g., MR measurements). In such aspects, when performing an RRM procedure, the UE 120 may adjust each of the multiple sets of measurements by a respective transmit power boosting factor, which is described in more detail below in connection with reference number 540.

Additionally, or alternatively, in some aspects, the configuration information may configure one or more thresholds associated with combining measurements. For example, the configuration may include an indication of an RSRP threshold, an RSRQ threshold, an SINR threshold, or a similar threshold. In such aspects, the UE 120 may be configured to only combine measurements if one or more sets of measurements meet a configured threshold and/or if two sets of measurements to be combined differ by less than a configured threshold. Aspects of an RSRP threshold, an RSRQ threshold, an SINR threshold, or a similar threshold are described in more detail below in connection with reference number 540.

In some aspects, the configuration information may configure a maximum permissible frequency separation between an SSB or a similar communication associated with a MR, and an LP-SS or a similar communication associated with an MR. For example, the UE 120 may be configured to only combine measurements when the first RRM communication (e.g., an LP-SS) is separated, in a frequency domain, from the second RRM communication (e.g., an SSB) by no more than the maximum permissible frequency separation, which is described in more detail below in connection with reference number 540. Moreover, in some aspects, the maximum permissible frequency separation may be frequency-band dependent (e.g., the maximum permissible frequency separation may be configured for a frequency band in which the first RRM communication and the second RRM communication are received). In that regard, the configuration information may indicate multiple maximum permissible frequency separation values, each associated with a different frequency band. In such aspects, when configured to combine measurements, the UE 120 may identify a corresponding maximum permissible frequency separation value for a frequency band in which the first RRM communication and second RRM communication are received, and thus combine the measurements only if a separation, in a frequency domain, between the first RRM communication and second RRM communication is no more than the identified maximum permissible frequency separation value, which is described in more detail below in connection with reference number 540.

In some aspects, the configuration information may indicate certain parameters associated with filtering measurements to be combined. For example, the configuration information may indicate a first filter coefficient associated with the first set of one or more measurements (e.g., LP-WUR measurements) and a second filter coefficient associated with the second set of one or more measurements (e.g., MR measurements). Additionally, or alternatively, the configuration information may configure multiple filter coefficients for selection by the UE 120. For example, the configuration information may configure multiple coefficients, each associated with a type of radio and/or receiver (e.g., a first filter coefficient may be configured for a first type of WUR, a second filter coefficient may be configured for a second type of WUR, and so forth). In such aspects, when combining measurements, the UE 120 may select a coefficient, from the multiple coefficients, associated with a type of radio and/or receiver used to perform a corresponding set of measurements.

In some aspects, the configuration information may configure a combining period (sometimes referred to as a combining window and/or a combining Window parameter, which may be an upper-layer parameter) associated with combining measurements from two or more receivers, such as the combining period shown in connection with reference number 525. In some aspects, the combining Window parameter may be a layer 1 parameter, a layer 2 parameter, a layer 3 parameter, and/or the combining Window parameter may be upper-layer configured and/or updated. In such aspects, the UE 120 may be configured to combine measurements from multiple receivers when the measurements from the multiple receivers are received within the combining period and/or when the RRM communications associated with the measurements (e.g., an LP-SS, an SSB, or a similar communication) are received within the combining period, which is described in more detail below in connection with reference number 540.

The UE 120 may configure itself based at least in part on the configuration information. In some aspects, the UE 120 may be configured to perform one or more operations described herein based at least in part on the configuration information.

As shown by reference number 515, the network node 110 may transmit, and the UE 120 may receive, the first RRM communication (e.g., a communication associated with an LP-SS). Moreover, as shown by reference number 520, the network node 110 may transmit, and the UE 120 may receive, the second RRM communication (e.g., a communication associated with an SSB). In some aspects, the first RRM communication and the second RRM communication may be transmitted and/or received within a configured time period, such as the combining period shown in connection with reference number 525. As shown by reference numbers 530 and 535, based at least in part on the configuration information, the UE 120 may perform a first set of one or more measurements associated with the first RRM communication (e.g., an LP-SS) using the LP-WUR, and/or the UE 120 may perform a second set of one or more measurements associated with the second RRM communication (e.g., an SSB) using the MR. In some aspects, the UE 120 may perform the first set of one or more measurements and/or the second set of one or more measurements while the UE 120 is in an idle mode. In some other aspects, the UE 120 may perform the first set of one or more measurements and/or the second set of one or more measurements while the UE 120 is in a different mode, such as an inactive mode, a connected mode, or another RRC mode.

As shown by reference number 540, based at least in part on the configuration information, the UE 120 may combine the first set of one or more measurements and the second set of one or more measurements for a purpose of performing an RRM procedure (e.g., a cell-selection procedure), or else the UE 120 may select a set of one or more measurements, from the first set of one or more measurements or the second set of one or more measurements, for purposes of performing an RRM procedure. For example, when the configuredRRMmode IE is set to combine, the UE 120 may combine LP-WUR measurements and MR measurements for a purpose of triggering an RRM procedure. Moreover, when the configuredRRMmode IE is set to selection, the UE 120 may select a set of measurements that is associated with a highest measurement quantity (e.g., a highest measured RSRP, RSRQ, SINR, or the like). Furthermore, when the configuredRRMmode IE is set to worst-case, the UE 120 may select a set of measurements that is associated with a lowest measurement quantity (e.g., a lowest measured RSRP, RSRQ, SINR, or the like). Additionally, or alternatively, as shown by reference number 545, the UE 120 may trigger an RRM procedure using one of a combination of the first set of one or more measurements and the second set of one or more measurements, or a selection of a set of one or more measurements, from the first set of one or more measurements or the second set of one or more measurements. That is, the UE 120 may trigger the RRM procedure (e.g., a cell-selection procedure) based at least in part on a combination of measurements or a selected set of measurements, as configured by the configuration information.

In some aspects, the UE 120 may be configured to only combine measurements if the first RRM communication (e.g., the LP-SS) and the second RRM communication (e.g., the SSB) are associated with a same quasi co-location (QCL) source (e.g., if the first RRM communication and the second RRM communication are transmitted using the same beam). In such aspects, triggering the RRM procedure may include using the combination of the first set of one or more measurements and the second set of one or more measurements based at least in part on the first set of one or more measurements being associated with a same QCL source as a QCL source associated with the second set of one or more measurements. In some other aspects, the UE 120 may be configured to combine measurements regardless of whether the first RRM communication and the second RRM communication are associated with the same QCL source (e.g., the UE 120 may combine measurements even when the first set of one or more measurements is associated with a different QCL source than a QCL source associated with the second set of one or more measurements).

Moreover, in aspects in which the UE 120 is configured with a transmit power boosting factor associated with one of the first RRM communication and/or the second RRM configuration, as described above in connection with reference number 510, the UE 120 may adjust a set of measurements for purposes of combining with other measurements. For example, the UE 120 may trigger the RRM procedure using the combination of the first set of one or more measurements, adjusted based at least in part on the first transmit power boosting factor, and the second set of one or more measurements, adjusted based at least in part on the second transmit power boosting factor.

In aspects in which the UE 120 is configured with one or more thresholds (e.g., an RSRP threshold, an RSRQ threshold, an SINR threshold, or a similar threshold), the UE 120 may trigger the RRM procedure based at least in part on at least one set of measurements meeting a threshold and/or based on a difference between sets of measurements falling within a threshold. For example, in some aspects, the UE 120 may triggering the RRM procedure using the combination of the first set of one or more measurements and the second set of one or more measurements based at least in part on the first set of one or more measurements and the second set of one or more measurements satisfying an RSRP threshold, an RSRQ threshold, and/or an SINR threshold. In some other aspects, the UE 120 may trigger the RRM procedure using the combination of the first set of one or more measurements and the second set of one or more measurements based at least in part on the first set of one or more measurements differing from the second set of one or more measurements by less than an RSRP threshold, an RSRQ threshold, and/or an SINR threshold.

Additionally, or alternatively, in aspects in which the UE 120 is configured with a maximum permissible frequency separation, the UE 120 may trigger the RRM procedure using the combination of the first set of one or more measurements and the second set of one or more measurements, based at least in part on a frequency separation of an LP-SS associated with the first RRM communication and an SSB associated with the second RRM communication being within the maximum permissible frequency separation. For example, the UE 120 may be configured with a maximum permissible frequency separation of X MHz, and thus the UE 120 may combine the sets of measurements if the first RRM communication (e.g., the LP-SS) is separated, in a frequency domain, from the second RRM communication (e.g., the SSB) by no more than X MHz. As described above in connection with reference number 510, in some aspects, a maximum permissible frequency separation (e.g., X) may vary across frequency bands and/or may be configured per frequency band.

Moreover, in aspects in which the UE 120 is configured with one or more filter coefficients, such as a first filter coefficient associated with the first RRM communication (e.g., LP-SS) and/or the first set of one or more measurements, and/or a second filter coefficient associated with the second RRM communication (e.g., SSB) and/or the second set of one or more measurements, the UE 120 may trigger the RRM procedure using the combination of the first set of one or more measurements, adjusted based at least in part on the first filter coefficient, and the second set of one or more measurements, adjusted based at least in part on the second filter coefficient. In some other aspects, the UE 120 may be configured to determine one or more filter coefficients (e.g., the UE 120 may not be configured with explicit coefficients, but rather the filter coefficients may be determined at the UE 120). For example, one or more filter coefficients and/or one or more combining formulas may be determined by the UE 120 based at least in part on a training procedure performed by the UE 120, such as a training procedure performed while the UE 120 is in a connected mode, an idle mode, and/or an inactive mode.

Additionally, or alternatively, in aspects in which the UE 120 is configured with a combining period (e.g., via a combining Window parameter), the UE 120 may trigger the RRM procedure using the combination of the first set of one or more measurements and the second set of one or more measurements based at least in part on the UE performing the first set of one or more measurements and the second set of one or more measurements within the combining period (e.g., the combining period shown in connection with reference number 525).

Moreover, in some aspects, some measurements (e.g., the measurements of the second RRM communication described above in connection with reference number 535) may be performed by an MR after the UE 120 falsely wakes up in response to a group page (e.g., when the UE 120 inadvertently wakes up to receive a group page that was not intended for the UE 120) and/or in connection with a false alarm of an LP-WUS (e.g., when the UE 120 incorrectly determines that it received a WUS from the network node 110). In such aspects, the UE 120 may perform MR measurements (e.g., measurements of an SSB) while awake, and then combine those measurements with LP-WUR measurements performed before or after the MR performs measurements on an SSB. In such aspects, the UE 120 may trigger the RRM procedure using the combination of the first set of one or more measurements and the second set of one or more measurements, with the second set of one or more measurements being associated with one or more measurements performed while the UE 120 is falsely responding to one of a group page or a false low-power wake up signal.

Based at least in part on the UE 120 triggering an RRM procedure (e.g., a cell-selection procedure) using either a combination of LP-WUR measurements and MR measurements or a selection of one of LP-WUR measurements or MR measurements, the UE 120 and/or the network node 110 may conserve computing, power, network, and/or communication resources that may have otherwise been consumed by periodically waking up an MR to perform RRM measurements. For example, based at least in part on the UE 120 triggering an RRM procedure using a combination of LP-WUR measurements and MR measurements or a selection of one of LP-WUR measurements or MR measurements, the UE 120 and the network node 110 may perform RRM measurements using a low-power receiver, thereby reducing power consumption at the UE 120, while flexibly maintaining a robust communication link between the UE 120 and the network node 110 using MR measurements and/or LP-WUR measurements, thereby enabling communication with a reduced error rate and thus conserving computing, power, network, and/or communication resources that may have otherwise been consumed to detect and/or correct communication errors.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with measurements associated with a main radio and a low-power wake up receiver.

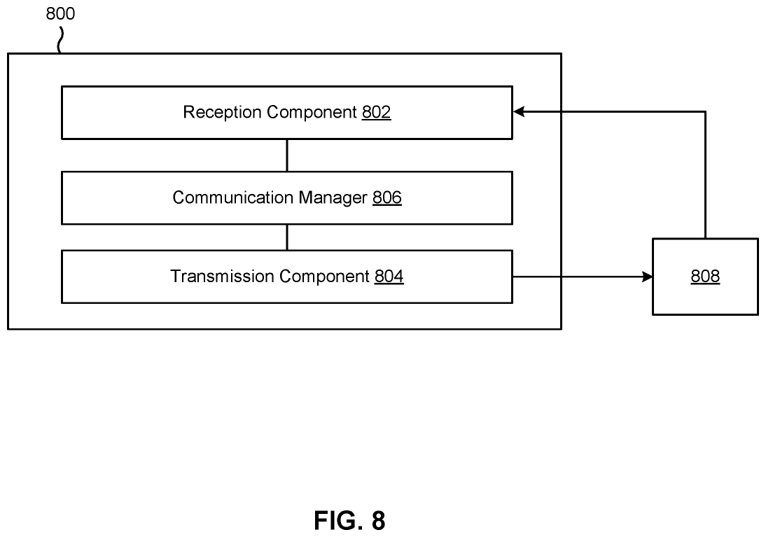

As shown in FIG. 6, in some aspects, process 600 may include receiving configuration information configuring measurement of a first RRM communication associated with an LP-WUR and a second RRM communication associated with an MR (block 610). For example, the UE (e.g., using reception component 802 and/or communication manager 806, depicted in FIG. 8) may receive configuration information configuring measurement of a first RRM communication associated with an LP-WUR and a second RRM communication associated with an MR, as described above.

As further shown in FIG. 6, in some aspects, process 600 may include performing, based at least in part on the configuration information, a first set of one or more measurements associated with the first RRM communication using the LP-WUR and a second set of one or more measurements associated with the second RRM communication using the MR (block 620). For example, the UE (e.g., using communication manager 806, depicted in FIG. 8) may perform, based at least in part on the configuration information, a first set of one or more measurements associated with the first RRM communication using the LP-WUR and a second set of one or more measurements associated with the second RRM communication using the MR, as described above.

As further shown in FIG. 6, in some aspects, process 600 may include triggering an RRM procedure using one of: a combination of the first set of one or more measurements and the second set of one or more measurements, or a selection of a set of one or more measurements, from the first set of one or more measurements or the second set of one or more measurements (block 630). For example, the UE (e.g., using communication manager 806, depicted in FIG. 8) may trigger an RRM procedure using one of: a combination of the first set of one or more measurements and the second set of one or more measurements, or a selection of a set of one or more measurements, from the first set of one or more measurements or the second set of one or more measurements, as described above.

Process 600 may include additional aspects, such as any single aspect or any combination of aspects described below and/or in connection with one or more other processes described elsewhere herein.

In a first aspect, the first RRM communication is associated with a low-power synchronization signal, and the second RRM communication is associated with a synchronization signal block.

In a second aspect, alone or in combination with the first aspect, process 600 includes transmitting capability information indicating UE support of LP-WUR measurements and MR measurements, wherein receiving the configuration information comprises receiving the configuration information based at least in part on the capability information.

In a third aspect, alone or in combination with one or more of the first and second aspects, performing the first set of one or more measurements and the second set of one or more measurements comprises performing at least one of the first set of one or more measurements or the second set of one or more measurements while the UE is in an idle mode.

In a fourth aspect, alone or in combination with one or more of the first through third aspects, the configuration information indicates that the UE is to trigger the RRM procedure based at least in part on one of a first mode associated with using the combination of the first set of one or more measurements and the second set of one or more measurements, a second mode associated with using a selection of a set of one or more measurements, from the first set of one or more measurements or the second set of one or more measurements, that is associated with a highest measurement quantity, or a third mode associated with using a selection of a set of one or more measurements, from the first set of one or more measurements or the second set of one or more measurements, that is associated with a lowest measurement quantity.

In a fifth aspect, alone or in combination with one or more of the first through fourth aspects, triggering the RRM procedure comprises triggering the RRM procedure using the combination of the first set of one or more measurements and the second set of one or more measurements based at least in part on the first set of one or more measurements being associated with a same QCL source as a QCL source associated with the second set of one or more measurements.

In a sixth aspect, alone or in combination with one or more of the first through fifth aspects, triggering the RRM procedure comprises triggering the RRM procedure using the combination of the first set of one or more measurements and the second set of one or more measurements, and the first set of one or more measurements is associated with a different QCL source than a QCL source associated with the second set of one or more measurements.

In a seventh aspect, alone or in combination with one or more of the first through sixth aspects, process 600 includes receiving an indication of a first transmit power boosting factor associated with the first set of one or more measurements and a second transmit power boosting factor associated with the second set of one or more measurements, wherein triggering the RRM procedure comprises triggering the RRM procedure using the combination of the first set of one or more measurements and the second set of one or more measurements based on the first transmit power boosting factor and the second transmit power boosting factor.

In an eighth aspect, alone or in combination with one or more of the first through seventh aspects, process 600 includes receiving an indication of at least one of an RSRP threshold, an RSRQ threshold, or an SINR threshold, wherein triggering the RRM procedure comprises triggering the RRM procedure using the combination of the first set of one or more measurements and the second set of one or more measurements based at least in part on the first set of one or more measurements and the second set of one or more measurements satisfying the at least one of the RSRP threshold, the RSRQ threshold, or the SINR threshold.

In a ninth aspect, alone or in combination with one or more of the first through eighth aspects, process 600 includes receiving an indication of at least one of an RSRP threshold, an RSRQ threshold, or an SINR threshold, wherein triggering the RRM procedure comprises triggering the RRM procedure using the combination of the first set of one or more measurements and the second set of one or more measurements based at least in part on the first set of one or more measurements differing from the second set of one or more measurements by less than the at least one of the RSRP threshold, the RSRQ threshold, or the SINR threshold.

In a tenth aspect, alone or in combination with one or more of the first through ninth aspects, process 600 includes receiving an indication of a maximum permissible frequency separation between an SSB and an LP-SS, wherein triggering the RRM procedure comprises triggering the RRM procedure using the combination of the first set of one or more measurements and the second set of one or more measurements based at least in part on a frequency separation of an LP-SS associated with the first RRM communication and an SSB associated with the second RRM communication being within the maximum permissible frequency separation.

In an eleventh aspect, alone or in combination with one or more of the first through tenth aspects, the maximum permissible frequency separation is configured, by the configuration information, for a frequency band in which the first RRM communication and the second RRM communication are received.

In a twelfth aspect, alone or in combination with one or more of the first through eleventh aspects, process 600 includes receiving an indication of a first filter coefficient associated with the first set of one or more measurements and a second filter coefficient associated with the second set of one or more measurements, wherein triggering the RRM procedure comprises triggering the RRM procedure using the combination of the first set of one or more measurements, adjusted based at least in part on the first filter coefficient, and the second set of one or more measurements, adjusted based at least in part on the second filter coefficient.

In a thirteenth aspect, alone or in combination with one or more of the first through twelfth aspects, the first filter coefficient is associated with a WUR class associated with the LP-WUR.

In a fourteenth aspect, alone or in combination with one or more of the first through thirteenth aspects, process 600 includes receiving an indication of a combining period, wherein triggering the RRM procedure comprises triggering the RRM procedure using the combination of the first set of one or more measurements and the second set of one or more measurements based at least in part on the UE performing the first set of one or more measurements and the second set of one or more measurements within the combining period.

In a fifteenth aspect, alone or in combination with one or more of the first through fourteenth aspects, triggering the RRM procedure comprises triggering the RRM procedure using the combination of the first set of one or more measurements and the second set of one or more measurements, and the second set of one or more measurements is associated with one or more measurements performed while the UE is responding to one of a group page or a false low-power wake up signal.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with measurements associated with a main radio and a low-power wake up receiver.

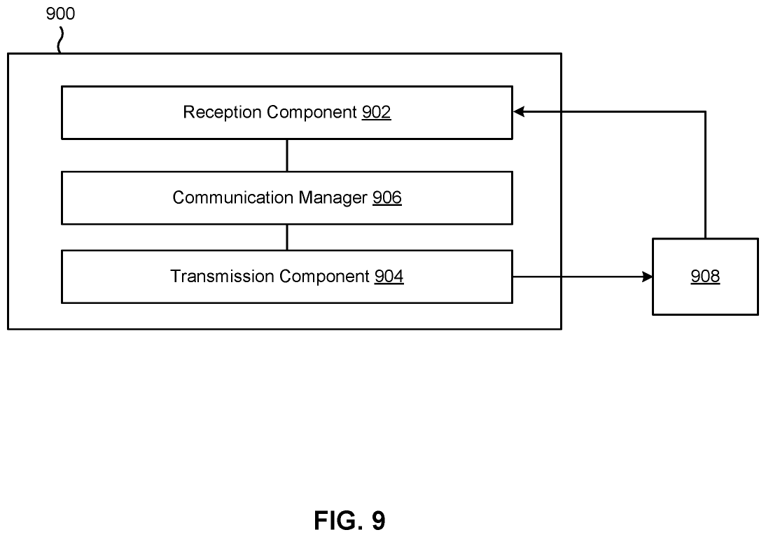

As shown in FIG. 7, in some aspects, process 700 may include transmitting, to a UE, configuration information configuring measurement of a first RRM communication associated with an LP-WUR and a second RRM communication associated with an MR (block 710). For example, the network node (e.g., using transmission component 904 and/or communication manager 906, depicted in FIG. 9) may transmit, to a UE, configuration information configuring measurement of a first RRM communication associated with an LP-WUR and a second RRM communication associated with an MR, as described above.

As further shown in FIG. 7, in some aspects, process 700 may include transmitting, to the UE, the first RRM communication and the second RRM communication (block 720). For example, the network node (e.g., using transmission component 904 and/or communication manager 906, depicted in FIG. 9) may transmit, to the UE, the first RRM communication and the second RRM communication, as described above.

As further shown in FIG. 7, in some aspects, process 700 may include receiving, from the UE, a message triggering an RRM procedure that is based at least in part on one of: a combination of a first set of one or more measurements associated with the first RRM communication and a second set of one or more measurements associated with the second RRM communication, or a selection of a set of one or more measurements, from the first set of one or more measurements or the second set of one or more measurements (block 730). For example, the network node (e.g., using reception component 902 and/or communication manager 906, depicted in FIG. 9) may receive, from the UE, a message triggering an RRM procedure that is based at least in part on one of: a combination of a first set of one or more measurements associated with the first RRM communication and a second set of one or more measurements associated with the second RRM communication, or a selection of a set of one or more measurements, from the first set of one or more measurements or the second set of one or more measurements, as described above.

Process 700 may include additional aspects, such as any single aspect or any combination of aspects described below and/or in connection with one or more other processes described elsewhere herein.

In a first aspect, the first RRM communication is associated with a low-power synchronization signal, and the second RRM communication is associated with a synchronization signal block.

In a second aspect, alone or in combination with the first aspect, process 700 includes receiving, from the UE, capability information indicating UE support of LP-WUR measurements and MR measurements, wherein transmitting the configuration information comprises transmitting, to the UE, the configuration information based at least in part on the capability information.

In a third aspect, alone or in combination with one or more of the first and second aspects, transmitting the first RRM communication and the second RRM communication comprises transmitting, to the UE, at least one of the first RRM communication or the second RRM communication while the UE is in an idle mode.

In a fourth aspect, alone or in combination with one or more of the first through third aspects, the configuration information indicates that the UE is to trigger the RRM procedure based at least in part on one of a first mode associated with using the combination of the first set of one or more measurements and the second set of one or more measurements, a second mode associated with using a selection of a set of one or more measurements, from the first set of one or more measurements or the second set of one or more measurements, that is associated with a highest measurement quantity, or a third mode associated with using a selection of a set of one or more measurements, from the first set of one or more measurements or the second set of one or more measurements, that is associated with a lowest measurement quantity.

In a fifth aspect, alone or in combination with one or more of the first through fourth aspects, the message triggering the RRM procedure is based at least in part on the combination of the first set of one or more measurements and the second set of one or more measurements based at least in part on the first set of one or more measurements being associated with a QCL source as a QCL source associated with the second set of one or more measurements.

In a sixth aspect, alone or in combination with one or more of the first through fifth aspects, the message triggering the RRM procedure is based at least in part on the combination of the first set of one or more measurements and the second set of one or more measurements, and the first set of one or more measurements is associated with a different QCL source than a QCL source associated with the second set of one or more measurements.

In a seventh aspect, alone or in combination with one or more of the first through sixth aspects, process 700 includes transmitting, to the UE, an indication of a first transmit power boosting factor associated with the first set of one or more measurements and a second transmit power boosting factor associated with the second set of one or more measurements, wherein the message triggering the RRM procedure is based at least in part on the combination of the first set of one or more measurements and the second set of one or more measurements based on the first transmit power boosting factor and the second transmit power boosting factor.

In an eighth aspect, alone or in combination with one or more of the first through seventh aspects, process 700 includes transmitting, to the UE, an indication of at least one of an RSRP threshold, an RSRQ threshold, or an SINR threshold, wherein the message triggering the RRM procedure is based at least in part on the combination of the first set of one or more measurements and the second set of one or more measurements based at least in part on the first set of one or more measurements and the second set of one or more measurements satisfying the at least one of the RSRP threshold, the RSRQ threshold, or the SINR threshold.

In a ninth aspect, alone or in combination with one or more of the first through eighth aspects, process 700 includes transmitting, to the UE, an indication of at least one of an RSRP threshold, an RSRQ threshold, or an SINR threshold, wherein the message triggering the RRM procedure is based at least in part on the combination of the first set of one or more measurements and the second set of one or more measurements based at least in part on the first set of one or more measurements differing from the second set of one or more measurements by less than the at least one of the RSRP threshold, the RSRQ threshold, or the SINR threshold.

In a tenth aspect, alone or in combination with one or more of the first through ninth aspects, process 700 includes transmitting, to the UE, an indication of a maximum permissible frequency separation between an SSB and an LP-SS, wherein the message triggering the RRM procedure is based at least in part on the combination of the first set of one or more measurements and the second set of one or more measurements based at least in part on a frequency separation of an LP-SS associated with the first RRM communication and an SSB associated with the second RRM communication being within the maximum permissible frequency separation.

In an eleventh aspect, alone or in combination with one or more of the first through tenth aspects, the maximum permissible frequency separation is configured, by the configuration information, for a frequency band in which the first RRM communication and the second RRM communication are transmitted.

In a twelfth aspect, alone or in combination with one or more of the first through eleventh aspects, process 700 includes transmitting, to the UE, an indication of a first filter coefficient associated with the first set of one or more measurements and a second filter coefficient associated with the second set of one or more measurements, wherein the message triggering the RRM procedure is based at least in part on the combination of the first set of one or more measurements, adjusted based at least in part on the first filter coefficient, and the second set of one or more measurements, adjusted based at least in part on the second filter coefficient.

In a thirteenth aspect, alone or in combination with one or more of the first through twelfth aspects, the first filter coefficient is associated with a WUR class associated with the LP-WUR.

In a fourteenth aspect, alone or in combination with one or more of the first through thirteenth aspects, process 700 includes transmitting, to the UE, an indication of a combining period, wherein the message triggering the RRM procedure is based at least in part on the combination of the first set of one or more measurements and the second set of one or more measurements based at least in part on the first RRM communication and the second RRM communication being transmitted within the combining period.

In a fifteenth aspect, alone or in combination with one or more of the first through fourteenth aspects, the message triggering the RRM procedure is based at least in part on the combination of the first set of one or more measurements and the second set of one or more measurements, and the second set of one or more measurements is associated with one or more measurements performed while the UE is responding to one of a group page or a false low-power wake up signal.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE 120 described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE 120 described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE 120 described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive configuration information configuring measurement of a first RRM communication associated with an LP-WUR and a second RRM communication associated with an MR. The communication manager 806 may perform, based at least in part on the configuration information, a first set of one or more measurements associated with the first RRM communication using the LP-WUR and a second set of one or more measurements associated with the second RRM communication using the MR. The communication manager 806 may trigger an RRM procedure using one of a combination of the first set of one or more measurements and the second set of one or more measurements, or a selection of a set of one or more measurements, from the first set of one or more measurements or the second set of one or more measurements.

The transmission component 804 may transmit capability information indicating UE support of LP-WUR measurements and MR measurements, wherein receiving the configuration information comprises receiving the configuration information based at least in part on the capability information.

The reception component 802 may receive an indication of a first transmit power boosting factor associated with the first set of one or more measurements and a second transmit power boosting factor associated with the second set of one or more measurements, wherein triggering the RRM procedure comprises triggering the RRM procedure using the combination of the first set of one or more measurements and the second set of one or more measurements based on the first transmit power boosting factor and the second transmit power boosting factor.

The reception component 802 may receive an indication of at least one of an RSRP threshold, an RSRQ threshold, or an SINR threshold, wherein triggering the RRM procedure comprises triggering the RRM procedure using the combination of the first set of one or more measurements and the second set of one or more measurements based at least in part on the first set of one or more measurements and the second set of one or more measurements satisfying the at least one of the RSRP threshold, the RSRQ threshold, or the SINR threshold.

The reception component 802 may receive an indication of at least one of an RSRP threshold, an RSRQ threshold, or an SINR threshold, wherein triggering the RRM procedure comprises triggering the RRM procedure using the combination of the first set of one or more measurements and the second set of one or more measurements based at least in part on the first set of one or more measurements differing from the second set of one or more measurements by less than the at least one of the RSRP threshold, the RSRQ threshold, or the SINR threshold.

The reception component 802 may receive an indication of a maximum permissible frequency separation between an SSB and an LP-SS, wherein triggering the RRM procedure comprises triggering the RRM procedure using the combination of the first set of one or more measurements and the second set of one or more measurements based at least in part on a frequency separation of an LP-SS associated with the first RRM communication and an SSB associated with the second RRM communication being within the maximum permissible frequency separation.

The reception component 802 may receive an indication of a first filter coefficient associated with the first set of one or more measurements and a second filter coefficient associated with the second set of one or more measurements, wherein triggering the RRM procedure comprises triggering the RRM procedure using the combination of the first set of one or more measurements, adjusted based at least in part on the first filter coefficient, and the second set of one or more measurements, adjusted based at least in part on the second filter coefficient.

The reception component 802 may receive an indication of a combining period, wherein triggering the RRM procedure comprises triggering the RRM procedure using the combination of the first set of one or more measurements and the second set of one or more measurements based at least in part on the UE performing the first set of one or more measurements and the second set of one or more measurements within the combining period.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node 110 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node 110 described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node 110 described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, to a UE, configuration information configuring measurement of a first RRM communication associated with an LP-WUR and a second RRM communication associated with an MR. The transmission component 904 may transmit, to the UE, the first RRM communication and the second RRM communication. The reception component 902 may receive, from the UE, a message triggering an RRM procedure that is based at least in part on one of a combination of a first set of one or more measurements associated with the first RRM communication and a second set of one or more measurements associated with the second RRM communication, or a selection of a set of one or more measurements, from the first set of one or more measurements or the second set of one or more measurements.

The reception component 902 may receive, from the UE, capability information indicating UE support of LP-WUR measurements and MR measurements, wherein transmitting the configuration information comprises transmitting, to the UE, the configuration information based at least in part on the capability information.

The transmission component 904 may transmit, to the UE, an indication of a first transmit power boosting factor associated with the first set of one or more measurements and a second transmit power boosting factor associated with the second set of one or more measurements, wherein the message triggering the RRM procedure is based at least in part on the combination of the first set of one or more measurements and the second set of one or more measurements based on the first transmit power boosting factor and the second transmit power boosting factor.

The transmission component 904 may transmit, to the UE, an indication of at least one of an RSRP threshold, an RSRQ threshold, or an SINR threshold, wherein the message triggering the RRM procedure is based at least in part on the combination of the first set of one or more measurements and the second set of one or more measurements based at least in part on the first set of one or more measurements and the second set of one or more measurements satisfying the at least one of the RSRP threshold, the RSRQ threshold, or the SINR threshold.

The transmission component 904 may transmit, to the UE, an indication of at least one of an RSRP threshold, an RSRQ threshold, or an SINR threshold, wherein the message triggering the RRM procedure is based at least in part on the combination of the first set of one or more measurements and the second set of one or more measurements based at least in part on the first set of one or more measurements differing from the second set of one or more measurements by less than the at least one of the RSRP threshold, the RSRQ threshold, or the SINR threshold.

The transmission component 904 may transmit, to the UE, an indication of a maximum permissible frequency separation between an SSB and an LP-SS, wherein the message triggering the RRM procedure is based at least in part on the combination of the first set of one or more measurements and the second set of one or more measurements based at least in part on a frequency separation of an LP-SS associated with the first RRM communication and an SSB associated with the second RRM communication being within the maximum permissible frequency separation.

The transmission component 904 may transmit, to the UE, an indication of a first filter coefficient associated with the first set of one or more measurements and a second filter coefficient associated with the second set of one or more measurements, wherein the message triggering the RRM procedure is based at least in part on the combination of the first set of one or more measurements, adjusted based at least in part on the first filter coefficient, and the second set of one or more measurements, adjusted based at least in part on the second filter coefficient.

The transmission component 904 may transmit, to the UE, an indication of a combining period, wherein the message triggering the RRM procedure is based at least in part on the combination of the first set of one or more measurements and the second set of one or more measurements based at least in part on the first RRM communication and the second RRM communication being transmitted within the combining period.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving configuration information configuring measurement of a first RRM communication associated with an LP-WUR and a second RRM communication associated with an MR; performing, based at least in part on the configuration information, a first set of one or more measurements associated with the first RRM communication using the LP-WUR and a second set of one or more measurements associated with the second RRM communication using the MR; and triggering an RRM procedure using one of: a combination of the first set of one or more measurements and the second set of one or more measurements, or a selection of a set of one or more measurements, from the first set of one or more measurements or the second set of one or more measurements.

Aspect 2: The method of Aspect 1, wherein the first RRM communication is associated with a low-power synchronization signal, and wherein the second RRM communication is associated with a synchronization signal block.

Aspect 3: The method of any of Aspects 1-2, further comprising: transmitting capability information indicating UE support of LP-WUR measurements and MR measurements, wherein receiving the configuration information comprises receiving the configuration information based at least in part on the capability information.

Aspect 4: The method of any of Aspects 1-3, wherein performing the first set of one or more measurements and the second set of one or more measurements comprises performing at least one of the first set of one or more measurements or the second set of one or more measurements while the UE is in an idle mode.

Aspect 5: The method of any of Aspects 1-4, wherein the configuration information indicates that the UE is to trigger the RRM procedure based at least in part on one of: a first mode associated with using the combination of the first set of one or more measurements and the second set of one or more measurements, a second mode associated with using a selection of a set of one or more measurements, from the first set of one or more measurements or the second set of one or more measurements, that is associated with a highest measurement quantity, or a third mode associated with using a selection of a set of one or more measurements, from the first set of one or more measurements or the second set of one or more measurements, that is associated with a lowest measurement quantity.

Aspect 6: The method of any of Aspects 1-5, wherein triggering the RRM procedure comprises triggering the RRM procedure using the combination of the first set of one or more measurements and the second set of one or more measurements based at least in part on the first set of one or more measurements being associated with a same QCL source as a QCL source associated with the second set of one or more measurements.

Aspect 7: The method of any of Aspects 1-6, wherein triggering the RRM procedure comprises triggering the RRM procedure using the combination of the first set of one or more measurements and the second set of one or more measurements, wherein the first set of one or more measurements is associated with a different QCL source than a QCL source associated with the second set of one or more measurements.

Aspect 8: The method of any of Aspects 1-7, further comprising: receiving an indication of a first transmit power boosting factor associated with the first set of one or more measurements and a second transmit power boosting factor associated with the second set of one or more measurements, wherein triggering the RRM procedure comprises triggering the RRM procedure using the combination of the first set of one or more measurements and the second set of one or more measurements based on the first transmit power boosting factor and the second transmit power boosting factor.

Aspect 9: The method of any of Aspects 1-8, further comprising: receiving an indication of at least one of an RSRP threshold, an RSRQ threshold, or an SINR threshold, wherein triggering the RRM procedure comprises triggering the RRM procedure using the combination of the first set of one or more measurements and the second set of one or more measurements based at least in part on the first set of one or more measurements and the second set of one or more measurements satisfying the at least one of the RSRP threshold, the RSRQ threshold, or the SINR threshold.

Aspect 10: The method of any of Aspects 1-9, further comprising: receiving an indication of at least one of an RSRP threshold, an RSRQ threshold, or an SINR threshold, wherein triggering the RRM procedure comprises triggering the RRM procedure using the combination of the first set of one or more measurements and the second set of one or more measurements based at least in part on the first set of one or more measurements differing from the second set of one or more measurements by less than the at least one of the RSRP threshold, the RSRQ threshold, or the SINR threshold.

Aspect 11: The method of any of Aspects 1-10, further comprising: receiving an indication of a maximum permissible frequency separation between an SSB and an LP-SS, wherein triggering the RRM procedure comprises triggering the RRM procedure using the combination of the first set of one or more measurements and the second set of one or more measurements based at least in part on a frequency separation of an LP-SS associated with the first RRM communication and an SSB associated with the second RRM communication being within the maximum permissible frequency separation.

Aspect 12: The method of Aspect 11, wherein the maximum permissible frequency separation is configured, by the configuration information, for a frequency band in which the first RRM communication and the second RRM communication are received.

Aspect 13: The method of any of Aspects 1-12, further comprising: receiving an indication of a first filter coefficient associated with the first set of one or more measurements and a second filter coefficient associated with the second set of one or more measurements, wherein triggering the RRM procedure comprises triggering the RRM procedure using the combination of the first set of one or more measurements, adjusted based at least in part on the first filter coefficient, and the second set of one or more measurements, adjusted based at least in part on the second filter coefficient.

Aspect 14: The method of Aspect 13, wherein the first filter coefficient is associated with a WUR class associated with the LP-WUR.

Aspect 15: The method of any of Aspects 1-14, further comprising: receiving an indication of a combining period, wherein triggering the RRM procedure comprises triggering the RRM procedure using the combination of the first set of one or more measurements and the second set of one or more measurements based at least in part on the UE performing the first set of one or more measurements and the second set of one or more measurements within the combining period.

Aspect 16: The method of any of Aspects 1-15, wherein triggering the RRM procedure comprises triggering the RRM procedure using the combination of the first set of one or more measurements and the second set of one or more measurements, wherein the second set of one or more measurements is associated with one or more measurements performed while the UE is responding to one of a group page or a false low-power wake up signal.

Aspect 17: A method of wireless communication performed by a network node, comprising: transmitting, to a UE, configuration information configuring measurement of a first RRM communication associated with an LP-WUR and a second RRM communication associated with an MR; transmitting, to the UE, the first RRM communication and the second RRM communication; and receiving, from the UE, a message triggering an RRM procedure that is based at least in part on one of: a combination of a first set of one or more measurements associated with the first RRM communication and a second set of one or more measurements associated with the second RRM communication, or a selection of a set of one or more measurements, from the first set of one or more measurements or the second set of one or more measurements.

Aspect 18: The method of Aspect 17, wherein the first RRM communication is associated with a low-power synchronization signal, and wherein the second RRM communication is associated with a synchronization signal block.

Aspect 19: The method of any of Aspects 17-18, further comprising: receiving, from the UE, capability information indicating UE support of LP-WUR measurements and MR measurements, wherein transmitting the configuration information comprises transmitting, to the UE, the configuration information based at least in part on the capability information.

Aspect 20: The method of any of Aspects 17-19, wherein transmitting the first RRM communication and the second RRM communication comprises transmitting, to the UE, at least one of the first RRM communication or the second RRM communication while the UE is in an idle mode.

Aspect 21: The method of any of Aspects 17-20, wherein the configuration information indicates that the UE is to trigger the RRM procedure based at least in part on one of: a first mode associated with using the combination of the first set of one or more measurements and the second set of one or more measurements, a second mode associated with using a selection of a set of one or more measurements, from the first set of one or more measurements or the second set of one or more measurements, that is associated with a highest measurement quantity, or a third mode associated with using a selection of a set of one or more measurements, from the first set of one or more measurements or the second set of one or more measurements, that is associated with a lowest measurement quantity.

Aspect 22: The method of any of Aspects 17-21, wherein the message triggering the RRM procedure is based at least in part on the combination of the first set of one or more measurements and the second set of one or more measurements based at least in part on the first set of one or more measurements being associated with a same QCL source as a QCL source associated with the second set of one or more measurements.

Aspect 23: The method of any of Aspects 17-22, wherein the message triggering the RRM procedure is based at least in part on the combination of the first set of one or more measurements and the second set of one or more measurements, and wherein the first set of one or more measurements is associated with a different QCL source than a QCL source associated with the second set of one or more measurements.

Aspect 24: The method of any of Aspects 17-23, further comprising: transmitting, to the UE, an indication of a first transmit power boosting factor associated with the first set of one or more measurements and a second transmit power boosting factor associated with the second set of one or more measurements, wherein the message triggering the RRM procedure is based at least in part on the combination of the first set of one or more measurements and the second set of one or more measurements based on the first transmit power boosting factor and the second transmit power boosting factor.

Aspect 25: The method of any of Aspects 17-24, further comprising: transmitting, to the UE, an indication of at least one of an RSRP threshold, an RSRQ threshold, or an SINR threshold, wherein the message triggering the RRM procedure is based at least in part on the combination of the first set of one or more measurements and the second set of one or more measurements based at least in part on the first set of one or more measurements and the second set of one or more measurements satisfying the at least one of the RSRP threshold, the RSRQ threshold, or the SINR threshold.

Aspect 26: The method of any of Aspects 17-25, further comprising: transmitting, to the UE, an indication of at least one of an RSRP threshold, an RSRQ threshold, or an SINR threshold, wherein the message triggering the RRM procedure is based at least in part on the combination of the first set of one or more measurements and the second set of one or more measurements based at least in part on the first set of one or more measurements differing from the second set of one or more measurements by less than the at least one of the RSRP threshold, the RSRQ threshold, or the SINR threshold.

Aspect 27: The method of any of Aspects 17-26, further comprising: transmitting, to the UE, an indication of a maximum permissible frequency separation between an SSB and an LP-SS, wherein the message triggering the RRM procedure is based at least in part on the combination of the first set of one or more measurements and the second set of one or more measurements based at least in part on a frequency separation of an LP-SS associated with the first RRM communication and an SSB associated with the second RRM communication being within the maximum permissible frequency separation.

Aspect 28: The method of Aspect 27, wherein the maximum permissible frequency separation is configured, by the configuration information, for a frequency band in which the first RRM communication and the second RRM communication are transmitted.

Aspect 29: The method of any of Aspects 17-28, further comprising: transmitting, to the UE, an indication of a first filter coefficient associated with the first set of one or more measurements and a second filter coefficient associated with the second set of one or more measurements, wherein the message triggering the RRM procedure is based at least in part on the combination of the first set of one or more measurements, adjusted based at least in part on the first filter coefficient, and the second set of one or more measurements, adjusted based at least in part on the second filter coefficient.

Aspect 30: The method of Aspect 29, wherein the first filter coefficient is associated with a WUR class associated with the LP-WUR.

Aspect 31: The method of any of Aspects 17-30, further comprising: transmitting, to the UE, an indication of a combining period, wherein the message triggering the RRM procedure is based at least in part on the combination of the first set of one or more measurements and the second set of one or more measurements based at least in part on the first RRM communication and the second RRM communication being transmitted within the combining period.

Aspect 32: The method of any of Aspects 17-31, wherein the message triggering the RRM procedure is based at least in part on the combination of the first set of one or more measurements and the second set of one or more measurements, and wherein the second set of one or more measurements is associated with one or more measurements performed while the UE is responding to one of a group page or a false low-power wake up signal.

Aspect 33: An apparatus for wireless communication at a device, comprising a processor; memory coupled with the processor; and instructions stored in the memory and executable by the processor to cause the apparatus to perform the method of one or more of Aspects 1-32.

Aspect 34: A device for wireless communication, comprising a memory and one or more processors coupled to the memory, the one or more processors configured to perform the method of one or more of Aspects 1-32.

Aspect 35: An apparatus for wireless communication, comprising at least one means for performing the method of one or more of Aspects 1-32.

Aspect 36: A non-transitory computer-readable medium storing code for wireless communication, the code comprising instructions executable by a processor to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors coupled to the one or more memories, the one or more memories including instructions executable by the one or more processors to cause the UE to:
receive configuration information configuring measurement of a first radio resource management (RRM) communication associated with a low-power wake up receiver (LP-WUR) and a second RRM communication associated with a main radio (MR);
perform, based at least in part on the configuration information, a first set of one or more measurements associated with the first RRM communication using the LP-WUR and a second set of one or more measurements associated with the second RRM communication using the MR; and
trigger an RRM procedure using one of:
a combination of the first set of one or more measurements and the second set of one or more measurements, or
a selection of a set of one or more measurements, from the first set of one or more measurements or the second set of one or more measurements.

2. The UE of claim 1, wherein the first RRM communication is associated with a low-power synchronization signal, and wherein the second RRM communication is associated with a synchronization signal block.

3. The UE of claim 1, wherein the one or more memories further include instructions executable by the one or more processors to cause the UE to:
transmit capability information indicating UE support of LP-WUR measurements and MR measurements,
wherein the one or more memories include instructions executable by the one or more processors to cause the UE to, when receiving the configuration information, receive the configuration information based at least in part on the capability information.

4. The UE of claim 1, wherein the one or more memories include instructions executable by the one or more processors to cause the UE to, when performing the first set of one or more measurements and the second set of one or more measurements, perform at least one of the first set of one or more measurements or the second set of one or more measurements while the UE is in an idle mode.

5. The UE of claim 1, wherein the configuration information indicates that the UE is to trigger the RRM procedure based at least in part on one of:
a first mode associated with using the combination of the first set of one or more measurements and the second set of one or more measurements,
a second mode associated with using a selection of a set of one or more measurements, from the first set of one or more measurements or the second set of one or more measurements, that is associated with a highest measurement quantity, or
a third mode associated with using a selection of a set of one or more measurements, from the first set of one or more measurements or the second set of one or more measurements, that is associated with a lowest measurement quantity.

6. The UE of claim 1, wherein the one or more memories include instructions executable by the one or more processors to cause the UE to, when triggering the RRM procedure, trigger the RRM procedure using the combination of the first set of one or more measurements and the second set of one or more measurements based at least in part on the first set of one or more measurements being associated with a same quasi co-location (QCL) source as a QCL source associated with the second set of one or more measurements.

7. The UE of claim 1, wherein the one or more memories include instructions executable by the one or more processors to cause the UE to, when triggering the RRM procedure, trigger the RRM procedure using the combination of the first set of one or more measurements and the second set of one or more measurements, and wherein the first set of one or more measurements is associated with a different quasi co-location (QCL) source than a QCL source associated with the second set of one or more measurements.

8. The UE of claim 1, wherein the one or more memories further include instructions executable by the one or more processors to cause the UE to:
receive an indication of a first transmit power boosting factor associated with the first set of one or more measurements and a second transmit power boosting factor associated with the second set of one or more measurements,
wherein the one or more memories include instructions executable by the one or more processors to cause the UE to, when triggering the RRM procedure, trigger the RRM procedure using the combination of the first set of one or more measurements and the second set of one or more measurements based on the first transmit power boosting factor and the second transmit power boosting factor.

9. The UE of claim 1, wherein the one or more memories further include instructions executable by the one or more processors to cause the UE to:
receive an indication of at least one of a reference signal received power (RSRP) threshold, a reference signal received quality (RSRQ) threshold, or a signal-to-interference-plus-noise ratio (SINR) threshold,
wherein the one or more memories include instructions executable by the one or more processors to cause the UE to, when triggering the RRM procedure, trigger the RRM procedure using the combination of the first set of one or more measurements and the second set of one or more measurements based at least in part on the first set of one or more measurements and the second set of one or more measurements satisfying the at least one of the RSRP threshold, the RSRQ threshold, or the SINR threshold.

10. The UE of claim 1, wherein the one or more memories further include instructions executable by the one or more processors to cause the UE to:
receive an indication of at least one of a reference signal received power (RSRP) threshold, a reference signal received quality (RSRQ) threshold, or a signal-to-interference-plus-noise ratio (SINR) threshold,
wherein the one or more memories include instructions executable by the one or more processors to cause the UE to, when triggering the RRM procedure, trigger the RRM procedure using the combination of the first set of one or more measurements and the second set of one or more measurements based at least in part on the first set of one or more measurements differing from the second set of one or more measurements by less than the at least one of the RSRP threshold, the RSRQ threshold, or the SINR threshold.

11. The UE of claim 1, wherein the one or more memories further include instructions executable by the one or more processors to cause the UE to:
receive an indication of a maximum permissible frequency separation between a synchronization signal block (SSB) and a low-power synchronization signal (LP-SS),
wherein the one or more memories include instructions executable by the one or more processors to cause the UE to, when triggering the RRM procedure, trigger the RRM procedure using the combination of the first set of one or more measurements and the second set of one or more measurements based at least in part on a frequency separation of an LP-SS associated with the first RRM communication and an SSB associated with the second RRM communication being within the maximum permissible frequency separation.

12. The UE of claim 11, wherein the maximum permissible frequency separation is configured, by the configuration information, for a frequency band in which the first RRM communication and the second RRM communication are received.

13. The UE of claim 1, wherein the one or more memories further include instructions executable by the one or more processors to cause the UE to:
receive an indication of a first filter coefficient associated with the first set of one or more measurements and a second filter coefficient associated with the second set of one or more measurements,
wherein the one or more memories include instructions executable by the one or more processors to cause the UE to, when triggering the RRM procedure, trigger the RRM procedure using the combination of the first set of one or more measurements, adjusted based at least in part on the first filter coefficient, and the second set of one or more measurements, adjusted based at least in part on the second filter coefficient.

14. The UE of claim 13, wherein the first filter coefficient is associated with a wake up receiver (WUR) class associated with the LP-WUR.

15. The UE of claim 1, wherein the one or more memories further include instructions executable by the one or more processors to cause the UE to:
receive an indication of a combining period,
wherein the one or more memories include instructions executable by the one or more processors to cause the UE to, when triggering the RRM procedure, trigger the RRM procedure using the combination of the first set of one or more measurements and the second set of one or more measurements based at least in part on the UE performing the first set of one or more measurements and the second set of one or more measurements within the combining period.

16. The UE of claim 1, wherein the one or more memories include instructions executable by the one or more processors to cause the UE to, when triggering the RRM procedure, trigger the RRM procedure using the combination of the first set of one or more measurements and the second set of one or more measurements, wherein the second set of one or more measurements is associated with one or more measurements performed while the UE is responding to one of a group page or a false low-power wake up signal.

17. A method of wireless communication performed by a user equipment (UE), comprising:
receiving configuration information configuring measurement of a first radio resource management (RRM) communication associated with a low-power wake up receiver (LP-WUR) and a second RRM communication associated with a main radio (MR);
performing, based at least in part on the configuration information, a first set of one or more measurements associated with the first RRM communication using the LP-WUR and a second set of one or more measurements associated with the second RRM communication using the MR; and
triggering an RRM procedure using one of:
a combination of the first set of one or more measurements and the second set of one or more measurements, or
a selection of a set of one or more measurements, from the first set of one or more measurements or the second set of one or more measurements.

18. The method of claim 17, wherein the first RRM communication is associated with a low-power synchronization signal, and wherein the second RRM communication is associated with a synchronization signal block.

19. The method of claim 17, further comprising:
transmitting capability information indicating UE support of LP-WUR measurements and MR measurements,
wherein receiving the configuration information comprises receiving the configuration information based at least in part on the capability information.

20. A non-transitory computer-readable medium storing one or more instructions for wireless communication, the one or more instructions, when executed by one or more processors of a user equipment (UE), cause the UE to:
receive configuration information configuring measurement of a first radio resource management (RRM) communication associated with a low-power wake up receiver (LP-WUR) and a second RRM communication associated with a main radio (MR);
perform, based at least in part on the configuration information, a first set of one or more measurements associated with the first RRM communication using the LP-WUR and a second set of one or more measurements associated with the second RRM communication using the MR; and
trigger an RRM procedure using one of:
a combination of the first set of one or more measurements and the second set of one or more measurements, or
a selection of a set of one or more measurements, from the first set of one or more measurements or the second set of one or more measurements.
